(19) United States
(12) Patent Application Publication
(10) Pub. No.: US 2007/0160954 A1
(43) Pub. Date: Jul. 12, 2007

(54) Method and device for regenerating bone in preparation for dental implant

(76) Inventor: Gregory Gene Steiner, Kapolei, HI (US)

Correspondence Address: GREGORY GENE STEINER, 590 FARRINGTON HWY. #524, SUITE 132, KAPOLEI, HI, 96707, US

(21) Appl. No.: 11/329,259

(22) Filed: Jan. 9, 2006

(51) Int. Cl. A61C 8/00

(52) U.S. Cl. 433/173

(57) ABSTRACT

The core is a device that is placed in an extraction socket. The core fills space that will be occupied by the implant thereby reducing the time needed to wait for implant placement because much less bone growth is needed. The core is also designed to prepare the socket for dental implant placement without the need for gingival flap surgery. The core is designed to make dental implant placement easier and simpler for both patient and practitioner.

### FIELD OF THE INVENTION

Bone graft surgery is a very common procedure in both medicine and dentistry. Bone grafts are used to fill bony defects caused by trauma or disease. The unfortunate removal of a tooth precipitates an initial loss of alveolar bone due to exposure of alveolar bone to the oral environment and the trauma of surgery. One of the greatest threats to the patient is osteomyelitis. Consequentially the body has developed a potent response to exposure of bone in order to protect the patient from infection.

Upon exposure of bone a significant resorptive response occurs in order to resorb the exposed calcified tissue and prevent infection. As the calcified portion of the exposed bone is being removed by osteoclasts the body rushes to cover the exposed bone with soft connective tissue and ultimately epithelium to ward against infection. This process continues resulting in a loss of portions of the alveolar bone and often complete loss of the buccal wall of the extraction socket. After the initial healing of the extraction site the alveolar ridge gradually resorbs resulting in loss of functional support for dental implants including esthetic compromises. Esthetic compromises resulting from loss of the alveolus is often an unacceptable relationship of the alveolar ridge and a prosthetic appliance. However, if a number of adjacent teeth are lost, facial deformity often occurs as a result of lack of support for the patients' lips and facial profile.

This invention is designed to quickly and economically treat the extraction socket to retain the maximum amount of alveolar bone and to stimulate bone formation in the extraction socket in preparation for dental implants. This invention is designed to allow dental implant placement is a shortened amount of time. This invention is also designed to prepare the socket for dental implant placement without the need for gingival flap surgery. This invention is designed to make dental implant placement easier and simpler for both patient and practitioner.

### BACKGROUND OF THE INVENTION

Over the years various methods and materials have been devised to limit the amount of alveolar bone lost after a tooth is removed. However, all of these methods have required a surgical procedure where incisions are made and a flap is raised to release the surrounding gingiva in order to cover the socket and bone graft. The procedure required a barrier be placed over the graft to contain the bone graft that filled the socket. The procedure required the use of a bone graft material, subgingival barriers and a surgical procedure to place the material.

In addition to socket regeneration procedures immediate implant placement has been proposed. However when placing an implant in bone immediately after tooth removal the coronal portion of the implant is not in contact with bone because at the coronal portion of the implant is narrower that the bony socket orifice. For this reason the coronal portion of the implant does not integrate resulting in chronic inflammation and probing defects. This invention permits the coronal portion of the extraction site to fill with bone so when the implant is placed the implant is fully integrated.

This invention requires no surgical procedure. The surrounding gingiva and underlying alveolar bone is undisturbed and a subgingival barrier is not required. In addition this invention only requires a minimal amount of bone regeneration which greatly reduces the amount of time between tooth removal and implant placement. This invention also provides an immediate temporary crown that maintains the gingiva and interdental papilla.

Prior Art

Socket preservation procedures to quickly regenerate bone in extraction sockets have been used for many years. Socket preservation has the intention of regenerating bone in the extraction socket after tooth removal. The term socket preservation is a misnomer. The methods are not intended to preserve the socket but regenerate the bone void left when a tooth is removed. A more appropriate term would be socket regeneration. Socket regeneration is designed to fill the socket with bone and maintain the alveolar ridge after tooth removal.

Many materials and methods have been designed to achieve socket regeneration. However previous methods focused on filling the socket with bone. The current method and device is intended to do the opposite. The current invention is designed to prevent bone from completely filling the socket. Because this invention approaches the problem in a completely new way there is no applicable prior art.

### BRIEF SUMMARY OF THE INVENTION

One embodiment of this invention is a device called a core that is placed in the fresh extraction socket. The core may be surrounded by a resorbable graft material designed to facilitate bone formation between the tooth socket and the core.

The core is of various lengths, widths and shapes depending on the implant that will replace the core. Because only the gap between the socket and the core needs to regenerate rather than having the entire socket fill with bone, the time between tooth removal and implant placement is greatly reduced. Because the core is aligned in the position of the previous tooth root, flap surgery is not needed when the core is placed or when the core is removed and the implant is placed. Because the core and surrounding bone graft can be covered with an ovate pontic the gingiva and papilla are also maintained.

The bone around the socket is protected from the oral cavity and is therefore preserved. With an ovate pontic the surrounding gingiva is preserved. Because the core is only slightly smaller than the future implant the amount of bone growth is reduced. This reduces the time between tooth removal and implant placement. The core is placed into the proper position at the time of tooth extraction. Therefore, the patient does not need gingival surgery and the skill required of the operator is reduced allowing for the skill level of a general dentist rather than requiring a skill level of a surgical specialist.

### BRIEF DESCRIPTION OF THE SEVERAL VIEWS OF THE DRAWING

FIG. 1 is a drawing of the anatomy of a tooth and its socket surrounded by bone.

FIG. 2 is a drawing of tooth replacement with an ovate temporary and core.

FIG. 3 is a drawing of an edentulous mandibular ridge.

FIG. 4 is a drawing of a ridge augmentation procedure using a core.

### DETAILED DESCRIPTION OF THE INVENTION

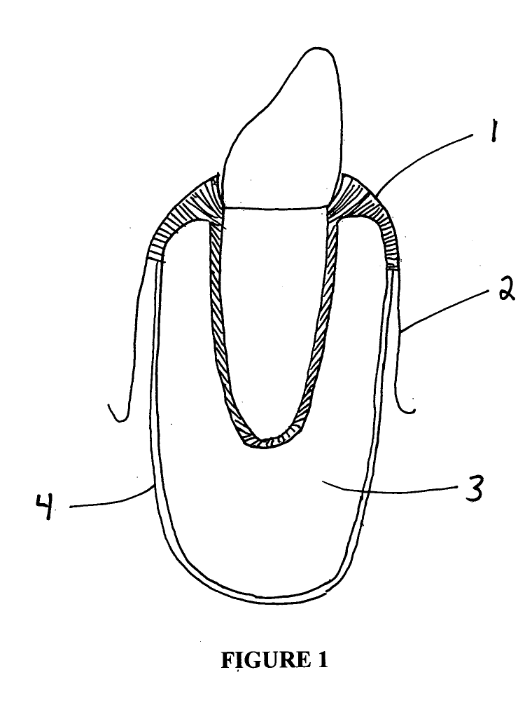

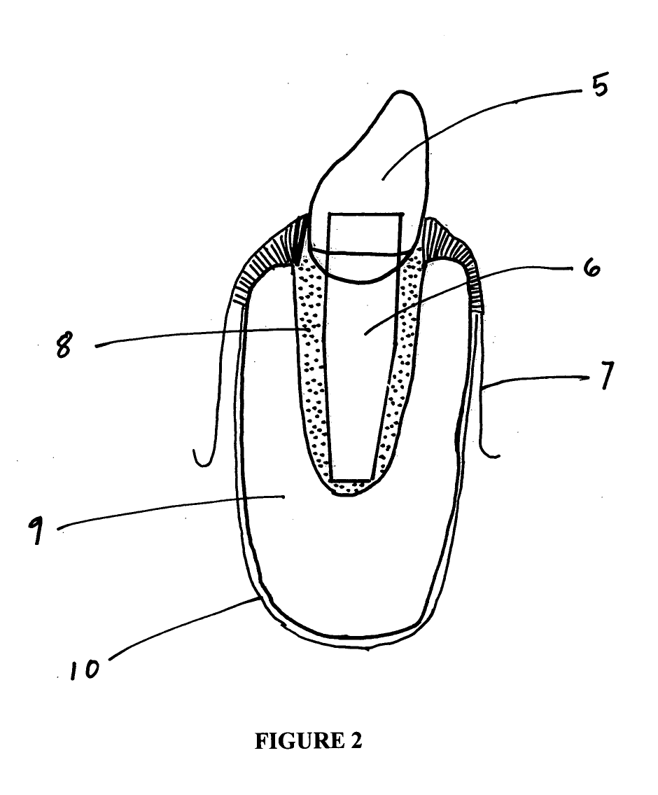

One aspect of this invention is a device that is placed into a site that will eventually receive a dental implant. The device is typically cylindrical in shape but may take on any shape that facilitates the placement of the future implant. The shape of the core is usually slightly smaller in diameter than the implant that is planned to replace it. The device is referred to as a core. The core is designed for simple insertion and removal. The core may have a beveled bottom so that when the core is rotated the core will lift out of the bone for easy removal. The top of the core may have slots or groves to permit engagement with an instrument to facilitate removal of the core. One such embodiment would be a straight cylinder slightly smaller than the intended future implant. Another embodiment of the core is a tapered cylinder that can be used for tapered implants. FIG. 1 shows the anatomy of a normal tooth in its socket surrounded by alveolar bone. #1 is the keratinized gingiva. #2 is the mucosa. #3 is the bone of the mandible. #4 is the periosteum. FIG. 2 is a diagram of tooth replacement with an ovate temporary and core. #5 is the ovate temporary. #6 is the core. #7 is the mucosa. #8 is the bone graft. #9 is the bone of the mandible. #10 is the periosteum. When the tooth of FIG. 1 is lost the socket is filled with bone graft material and the core is placed into the socket and shown in FIG. 2. In this embodiment the core fits into the base of the temporary. The temporary is stabilized by bonding to adjacent teeth. The bone graft is resorbed and replaced with bone. When the bone graft is replaced with bone the core is removed and an implant is placed in the resultant bone void.

The core provides a number of advantages for improved implant placement. One difficulty in implant placement is to achieve the proper angle and depth of the implant. With this invention the core is placed into the extraction socket to the depth and angle similar to that of the removed tooth. In this manner when the core is removed at the time of implant placement the void left will have the proper angle and depth needed for the implant. As a result the operator will not need to be concern about angle and depth when the implant is placed. This avoids damaging vital structures such as nerves and sinuses.

Because the operator does not need to be concerned about improper placement of the implant the operator does not need extensive surgical experience to place the implant. Also, because the void created by removal of the core is of the proper angle and depth the bone does not have to be exposed to gain access to bony landmarks in order to put the implant into proper position. The core is placed at the time of tooth removal which does not require gingival surgery. When the core is removed the bone void is the same as the osteotomy needed for traditional implant placement and therefore when the core is removed the implant is placed in the void with osteotomy and gingival surgery not needed. The operator can place the core and implant without gingival surgery reducing pain and morbidity.

One of the most important aspects of this invention is the ability to reduce the time between tooth loss and implant placement. When the tooth is removed the core is placed in the extraction socket. The core will be selected to be slightly smaller than the intended implant. The core will fill most of the extraction socket and therefore only very little bone will need to grow to fill the small space between the bone of the extraction socket and the core. Because very little bone fill is needed the bone fills the small void quickly and this allows the permanent implant to be placed in a much shorter period of time. If a tooth is extracted and an implant is planned a number of months are often required for the bone to fill in the socket to allow implant placement. When a core is placed in the extraction socket a much shorter time is needed between tooth removal and implant placement.

The use of a core reduces the skill needed to place a dental implant. When a tooth is removed and a core is placed the site is prepared for the operator upon removal of the core. Because gingival flap surgery is not needed and an osteotomy is not needed the operator does not need surgical skills to place the implant. Because surgery is not needed this invention allows the placement of dental implants by general dentists who may not have extensive surgical training.

The use of a core preserves the gingiva due to the ability to place an ovate pontic. The invention does not require gingival surgery. The method of the invention is easier because the operator does not need to prepare the implant site which allows for fewer surgical complications and reduces the amount of training required. The method of the invention has fewer post operative complications because it is less invasive.

Another embodiment of this invention is preparing resorbed edentulous ridges for dental implant placement. After teeth are lost the bone surrounding the teeth is often resorbed. In advanced cases resorption progresses to a point where there is not enough bone for implant placement. In these cases the only option is to perform ridge augmentation. To date the methods for ridge augmentation are very invasive and unpredictable. In this invention the bone of the edentulous ridge is exposed and cores are placed in the future dental implant sites. However, in this case the cores are only placed partially into the edentulous ridge with a portion of the core protruding from the ridge. The portion of the core not in bone is covered with bone graft material and the gingiva is sutured over the cores and bone graft. When the site heals the cores are removed and the implants are placed in the voids left by the cores.

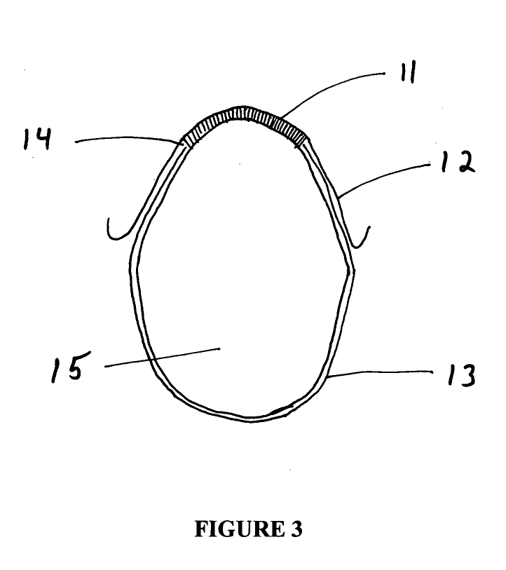

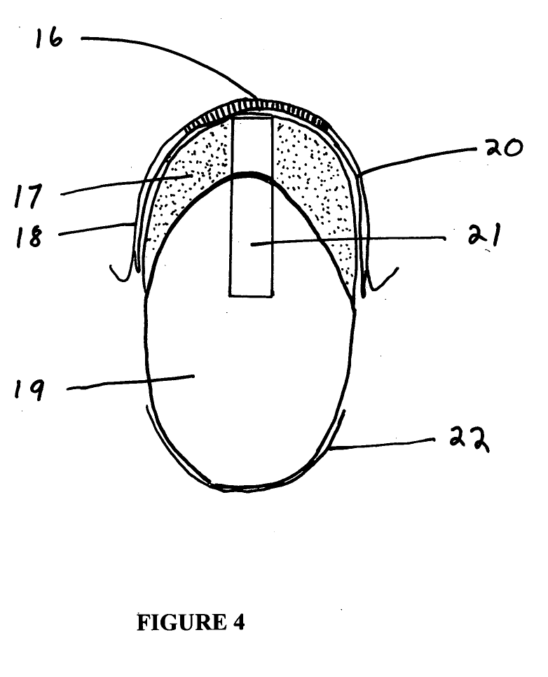

FIG. 3 is a diagram of an edentulous mandibular ridge. #11 is the keratinized gingiva. #12 is the mucosa. #13 is the periosteum. #14 is the mucogingival junction. FIG. 4 is a diagram of a ridge augmentation procedure using a core. #16 is the keratinized gingiva. #17 is the bone graft. #18 is the mucosa. #19 is the mandibular bone. #20 is the periosteum. #21 is the core. #22 is the periosteum of the inferior border of the mandible.

The keratinized gingiva is incised and the bone is exposed. The placement of the future dental implants are located and cores are placed in the respective locations. The cores are placed to a depth and angle to represent the ideal placement of the future implant. When the bone graft is converted into bone the cores are removed and implants are placed. The cores have the dual purpose of maintaining the graft site volume by supporting the gingiva during the healing phase and also locating the future implant depth and angle. After the bone graft has been converted into bone the cores are removed and implants are placed in the resulting bone void. This procedure makes ridge augmentation more predictable while making implant placement easier. The time between ridge augmentation and implant placement is shorter because the graft material can continue to mature after the permanent implants have been placed. For implant placement the operator merely needs to locate the cores and once removed the implants are inserted into the bone voids.

1. A device that is placed in an extraction site that when removed will form a bone void for implant placement.

2. As in claim 1 where the device is cylinder.

3. As in claim 1 where the device is a tapered cylinder.

4. As in claim 1 where the device material is metal, plastic or any material that when removed will form a bone void for implant placement.

5. A device that is placed in bone in an edentulous ridge that facilitates ridge augmentation and that when removed will create a bone void for implant placement.

6. As in claim 5 where the device is cylinder.

7. As in claim 5 where the device is a tapered cylinder.

8. As in claim 5 where the device material is metal, plastic or any material that when removed will form a bone void for implant placement.
